(19) United States
(12) Patent Application Publication
(10) Pub. No.: US 2005/0224176 A1
(43) Pub. Date: Oct. 13, 2005

(54) Apparatus and method for preparing shims to be applied to brake pads

(76) Inventor: Clifford Joe Murphy, Burkesville, KY (US)

Correspondence Address: HARNESS, DICKEY & PIERCE, P.L.C., P.O. BOX 828, BLOOMFIELD HILLS, MI, 48303, US

(21) Appl. No.: 10/818,868

(22) Filed: Apr. 6, 2004

(51) Int. Cl. B32B 1/00; F16D 65/40; B44C 1/165

(52) U.S. Cl. 156/344; 156/584; 156/540; 156/230

(57) ABSTRACT

An apparatus and method for removing a cover layer from a metallic brake shim has a container for holding the brake shims. A movable member moves into the container to remove a brake shim from the container. A conveyor is associated with the movable member to move the brake shim from the movable member to a work area. The conveyor includes a mechanism to retain the brake shim on the conveyor. Also, a member removes the cover layer from the shim as the shim moves along the conveyor toward the work area.

### BACKGROUND OF THE INVENTION

The present invention relates to brake pads and, more particularly, to a peeling device for preparing shims to be positioned onto a brake pad.

During the manufacturing of brake pads, in order to ensure proper tolerances, shims are added to the brake pad during manufacturing to provide desired tolerances. Ordinarily, the shims, which include an adhesive, also include a cover layer. During manufacturing, the cover layer is removed by an operator and the shim is positioned onto a conveying device. The conveying device moves the shim to an additional operator which, in turn, places it onto a brake pad. While this method works satisfactorily, it is labor intensive. Accordingly, it is desirable to provide an apparatus and mechanism to prepare the shim to be applied by the operator onto the brake pad.

In accordance with the present invention, an apparatus is provided which automatically grasp a shim from a container. The shim, with the cover layer, is positioned onto a conveyor. The cover layer is automatically removed from the shim as the conveyor moves the shim towards the operator. As the cover layer is removed, the cover layer is disposed of by the apparatus. Also, the apparatus senses when the shim is in a work area so that the conveyor can be halted until the shim is removed. Also, the shim is sensed to ensure that the cover layer has been removed.

From the following detailed description taken in conjunction with the subjoined claims, other objects and advantages of the present invention will become apparent to those skilled in the art.

### BRIEF DESCRIPTION OF THE DRAWINGS

FIG. 1 is a schematic view of a shim peeling apparatus in accordance with the present invention.

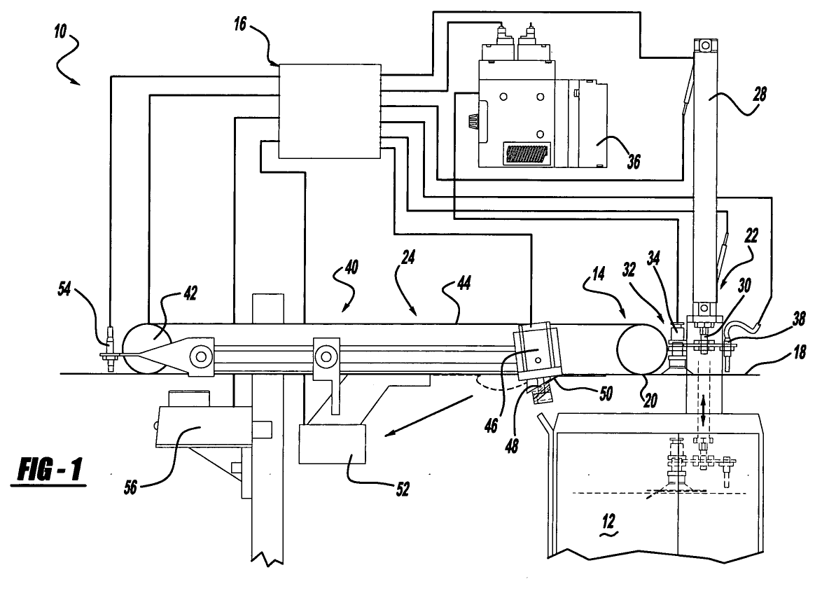

### DETAILED DESCRIPTION OF THE PREFERRED EMBODIMENTS

Turning to the figure, an apparatus to move a shim from a storage area to a work area is illustrated and designated with the reference numeral 10. The apparatus includes a shim container 12, as well as a transporting table 14 and a controller 16.

The container 12 is of the magazine type and may include a base which is movable in the magazine by a spring or the like. The shims 18 are loaded into the magazine container 12 with the cover layer 20 facing the bottom of the container 12.

The transporting table 14 includes a shim grasping section 22 and a conveying section 24. Supports 26 are coupled with the sections 22 and 24 to maintain the sections 22 and 24 above the ground at a desired height.

The grasping section 22 includes a non-rotating air cylinder 28 or the like which includes a movable piston rod 30. The piston rod 30 moves in and out of the cylinder 28 to extend the grasping section 22 into the magazine to retrieve shims 18. The piston rod 30 includes a shim pickup mechanism 32.

The shim pickup mechanism 32 includes a vacuum cup 34 associated with a vacuum generator 36. The vacuum generator 36 creates a vacuum at the vacuum cup 34 so that, when the piston rod 30 is extended into the container 12, it may retrieve a shim 18 as shown. Also, the shim pickup mechanism 32 includes a sensor 38. The sensor 38 is coupled with the controller 16 to indicate when a shim 18 may be or has been picked up by the vacuum cup 34. Also, the vacuum generator 36 is coupled with the controller 16 to control the vacuum at the vacuum cup 34 to grasp or release a shim 18.

The conveying portion 24 includes a conveyor 40. The conveyor includes rollers 42 and belt 44. The conveyor 40 is of the magnetic type wherein the belt 44 is provided with a magnetic force to maintain the metallic shims 18 on the belt 44. The conveyor 40 is coupled with the supports 26 to maintain the conveyor above the ground at its desired height. Also, the conveyor's movement mechanism is coupled with the controller 16.

A clamping air cylinder 46 is mounted with the conveyor portion 44. The clamping cylinder 46 includes a clamping mechanism 48. The clamping mechanism 48 grasps a tab 50 on the cover layer 20 in order to remove the cover layer 20 from the shim 18, as will be discussed herein. The air cylinder 46 is coupled with the controller 16.

A vacuum disposal 52 is also coupled with the conveying portion 24. The vacuum disposal 52 provides a disposal for the cover layers 20 as they are removed from the shims 18. The vacuum disposal 52 is also coupled with the controller 16. The controller 16 energizes and de-energizes the vacuum disposal 52 to dispose of the cover layers 20.

A sensor 54 is positioned in the work area at the end of the conveyor 40. The sensor 54 senses when a shim 18 is present in the work area. This enables removal by an operator. The sensor 54 is coupled with the controller 16.

A sensor 56 is positioned on one of the supports 26. The sensor 56 senses whether a cover layer 20 has been removed from the shim 18. The sensor 56 is coupled with the controller 16.

The controller 16, usually a microprocessor, is coupled with the elements as described to control pick up and delivery of the shims 18 to the operator. The controller 16 may be manually operated by the operator or it may operate automatically to deliver the shims 18 to the operator.

The controller 16, via sensor 38, determines whether or not a shim 18 is coupled with the vacuum cup 34. If the sensor 38 determines a shim 18 is not coupled with the vacuum cup 34, the controller sends a signal to the cylinder 28, which, in turn, extends piston rod 30 toward the magazine container 12. As the piston rod 30 extends, the sensor 38 senses a shim 18. The sensor 38 returns a signal to the controller 16 which initiates the vacuum generator 36. The vacuum generator 36 creates a vacuum at the vacuum cup 34. As this happens, a shim 18 is picked up by the vacuum cup 34 in the magazine container 12. The controller 16 returns the piston 30 into the cylinder 28 to its retracted position as illustrated in the figure. As this occurs, the metal shim 18 contacts the magnetic conveyor belt 44 of the conveyor 40.

The tab 50 of the cover layer 20 is positioned adjacent the clamping mechanism 48 of the air clamping cylinder 46. The controller 16 signals the air cylinder 46 to close, in turn clamping the tab 50 in the clamping mechanism 48. After this occurs, the controller 16 initiates movement of the conveyor 40 and in turn, belt 44 to move the shim 18 from the grasping area towards the work area.

The controller 16 signals the vacuum generator 36 to cut the vacuum to the vacuum cup 34. This releases the shim 18 from the vacuum cup 34 which enables the shim 18 to be magnetically connected with the conveyor belt 44 in the grasping area.

As the shim 18 moves from the grasping area to the work area, the cover layer 20 is removed from the shim 18. The cover layer tab 50 is still clamped and secured by the clamping mechanism 48. As the conveyor belt 44 moves toward the work area, the cover layer 20 is removed from the shim 18. When the cover layer 20 is almost removed from the shim 18, the controller 16 initiates the vacuum disposal 52. The vacuum disposal 52 is activated by controller 16 which draws the cover layer 20 towards the vacuum disposal 52. As the shim 18 moves past a desired position, the cover layer 20 is removed from the shim 18. At this time, the controller 16 signals the clamping cylinder 46 to release the clamping mechanism 48. As the clamping mechanism 48 is released which, in turn, releases the cover layer 20, the cover layer 20 is drawn into the vacuum disposal 52 and disposed of properly.

The shim 18, with the cover layer 20 removed, continues to move with the conveyor belt 44. When the shim 18 reaches the work area, it is sensed by the sensor 54. At this time, the sensor 54 sends a signal to the controller 16. The controller 16 signals the conveyor 40 to halt the belt 44 with the shim 18 positioned in the work area. The controller initiates sensor 56. The sensor 56 senses whether or not the cover layer 20 has been fully removed from the shim 18. If the cover layer 20 has been removed, the sensor 56 signals the controller 16 that the shim 18 is ready to be applied onto a brake pad. If the cover layer 20 is not removed, an audible or visual signal would be given to the operator so that the operator would know that the cover layer has not been removed.

After the shim 18 is removed from the conveyor belt 44 in the work area, the sensor 54 signals the controller 16 indicating that a new shim 18 is required in the work area. The above operation continues to supply shims from the grasping area to the working area during manufacture of the brake pads.

According to the invention, a method of removing a cover layer from a brake shim may be conducted as follows. A brake shim 18 is removed from a container 12 by the shim pickup mechanism 32, via vacuum cup 34. The shim 18 is moved from the container to the conveyor belt 44. The conveyor belt 44, via a magnetic force, attracts the metallic shim 18. The magnetic force maintains the metallic shim 18 onto the conveyor belt 44. After the metallic shim 18 has been contacted by the conveyor belt 44, the shim pickup mechanism 32 releases the shim 18.

While the shim 18 is contacted by the magnetic force of the conveyor belt 44, the clamping mechanism 48 of the clamping cylinder 46 clamps a tab 50 of the cover layer 20. With the tab 50 securely clamped by the clamping mechanism 48, the conveyor belt 44 begins moving the shim 18 from the grasping area towards the work area. As this occurs, the cover layer 20 begins to be removed from the shim 18 exposing the adhesive layer. As the shim 18 moves along the conveyor belt 44 and the cover layer 20 is almost removed from the shim 18, the vacuum disposal 52 is activated to draw the cover layer 20 into the vacuum disposal. As the cover layer is removed from the shim 18, the clamping mechanism 48 opens to release the cover layer 20 from the clamping mechanism 48. As this occurs, the cover layer 20 is drawn into the vacuum disposal 52 properly disposing of the cover layer 20.

The shim 18, with the adhesive layer exposed, continues to move toward the working area via the conveyor belt 44. Once the shim 18 reaches the working area, the shim 18 is sensed by sensor 54, which stops movement of the conveyor belt 44. Also, at this time, sensor 56 senses whether or not the cover layer has been removed from the shim 18. If the cover layer 20 has been removed from the shim 18, the shim may be removed from the conveyor belt 44 and applied to a brake pad. If the cover layer 20 has not been removed from the shim 18, a visual or audible signal will be given to the operator to indicate that the operator must remove the cover layer before applying it to a brake pad.

The description of the invention is merely exemplary in nature and, thus, variations that do not depart from the gist of the invention are intended to be within the scope of the invention. Such variations are not to be regarded as a departure from the spirit and scope of the invention.

1. An apparatus for removing a cover layer from a metallic brake shim comprising:
a container for holding shims with a cover layer;
a movable member for removing shims from said container, said movable member movable into and out of said container;
a conveyor associated with said movable member for moving a shim from said movable member to a work area, said conveyor including a mechanism for retaining a shim on said conveyor; and
a member for removing the cover layer from the shim as the shim moves along the conveyor toward the work area.

2. The apparatus according to claim 1 further comprising a sensor associated with said conveyor or determining when the shim is in the work area.

3. The apparatus according to claim 1 further comprising a sensor for determining that the cover layer has been removed from the shim when the shim is in the work area.

4. The apparatus according to claim 1 further comprising a disposal device for disposing of the cover layer as it is removed from the shim.

5. The apparatus according to claim 1 wherein said movable member includes a vacuum member for grasping the shim to remove the shim from the container.

6. The apparatus according to claim 1 wherein said conveyor retaining mechanism being a magnetic force for holding the shim on the conveyor.

7. The apparatus according to claim 1 wherein the shim cover layer includes a tab.

8. The apparatus according to claim 7 wherein said cover layer removing member grasps the tab to remove the cover layer.

9. A method of removing a covering layer from a brake shim comprising:
grasping a brake shim having a cover layer;
contacting said brake shim with a conveyor;
maintaining said brake shim on said conveyor;
grasping said cover layer on said brake shim;
moving said conveyor toward a work area;
removing said cover layer from said brake shim as said conveyor moves said brake shim towards a work area.

10. The method according to claim 9 further comprising sensing said brake shim when it reaches said work area.

11. The method according to claim 9 further comprising disposing of said cover layer as said cover layer is removed from said brake shim.

12. The method according to claim 9 further comprising creating a vacuum in a member to grasp said brake shim.

13. The method according to claim 9 further comprising creating a magnetic force in said conveyor for maintaining said brake shim on said conveyor.

14. The method according to claim 9 further comprising sensing said cover layer has been removed from said brake shim at said work area.

15. The method according to claim 9 further comprising removing said brake shim from said conveyor in said work area and applying said brake shim on a brake pad.

16. The method according to claim 9 further comprising sensing said brake shim being maintained on said conveyor and grasping said cover layer while said brake shim is maintained on said conveyor.
